(19) United States
(12) Patent Application Publication
(10) Pub. No.: US 2009/0298530 A1
(43) Pub. Date: Dec. 3, 2009

(54) COEXISTENCE SYSTEM

(75) Inventor: Dean Armstrong, Cambridgeshire (GB)

Correspondence Address: GREENBERG TRAURIG, LLP, 77 WEST WACKER DRIVE, SUITE 3100, CHICAGO, IL, 60601-1732, US

(73) Assignee: CAMBRIDGE SILICON RADIO LTD., Cambridge (GB)

(21) Appl. No.: 12/469,983

(22) Filed: May 21, 2009

(30) Foreign Application Priority Data
Jun. 3, 2008 (GB) 0810035.6

(51) Int. Cl. H04M 1/00

(52) U.S. Cl. 455/553.1

(57) ABSTRACT

A wireless communication system comprising a plurality of radio devices and an interconnect to facilitate sharing of resources between the plurality of radio devices. Each radio device is coupled to the interconnect such that each radio device can communicate to all of the other radio devices to facilitate sharing of resources and each radio device can ascertain the identity of a radio device sending a signal to the interconnect. The radio devices may be coupled to the interconnect by any suitable means, for example resistively or capacitively and the signals sent to the interconnect may be at baseband or at radio frequencies. Orthogonal code techniques may be utilized to allow the identification of each radio device.

### TECHNICAL FIELD

The present invention relates to a coexistence system for collocated radio transceivers. It is particularly related to, but in no way limited to, collocated radio transceivers operating in similar frequency regions.

### BACKGROUND

With the increasing use of Wi-Fi (i.e. IEEE 802.11) and Bluetooth™, many devices are being developed which include both Wi-Fi and Bluetooth capability. Examples include wireless VoIP (voice over internet protocol) telephones and smart phones. Although the Wi-Fi and Bluetooth radio systems are independent and use the spectrum differently, they both operate in the 2.4 GHz frequency band and therefore traffic in one system can cause interference for the other system. In some devices, where the isolation between the antenna ports for the two systems is low, simultaneous operation of the two systems is not possible because transmitting in one system results in front-end overload interference on the other system. Interference between collocated radio systems may also occur when the transmission bands of the radio systems do not overlap. For example, front-end overload may occur. Interference may also result from sharing sections of the radio front-end, for example an antenna, due to resource contention between the radio systems.

Coexistence schemes are used to allow collocated radio devices to communicate and coordinate sharing wireless resources. Current coexistence schemes utilize point to point links between radio devices to exchange information and coordinate sharing of resources. Such schemes require at least one connection for each direction of communication.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A wireless communication system comprising a plurality of radio devices and an interconnect to facilitate sharing of resources between the plurality of radio devices is described. Each radio device is coupled to the interconnect such that each radio device can communicate to all of the other radio devices to facilitate sharing of resources and each radio device can ascertain the identity of a radio device sending a signal to the interconnect. The radio devices may be coupled to the interconnect by any suitable means, for example resistively or capacitively and the signals sent to the interconnect may be at baseband or at radio frequencies. Orthogonal code techniques may be utilized to allow the identification of each radio device.

There is provided a wireless communications system, comprising a plurality of radio devices, an interconnect to which each of the radio devices is coupled, wherein each radio device is configured to send a utilization signal to the interconnect for reception by all other radio devices coupled to the interconnect, wherein the utilization signal comprises an indication of the identity of the radio device sending the signal and an indication of an intention to utilize a radio resource.

The radio devices may be resistively or capacitively coupled to the interconnect.

The utilization signal may be a baseband or a radio frequency signal.

Each radio device may be assigned a unique code indicating its identity.

The code of each radio device may be orthogonal to the code of each other radio device.

The utilization signal may comprise the code of the radio device sending that signal.

The identity of the radio device may be indicated by encoding the radio frequency signal with the code of the radio device sending the utilization signal.

The identity of the radio device may be indicated by the frequency of the utilization signal.

Three or more radio devices may be coupled to the interconnect.

The plurality of radio devices may be mounted on a single circuit board.

At least two of the radio devices may share an antenna.

The intended utilization of the radio resource may be for transmission of a signal.

The intended utilization of the radio resource may be for reception of a signal.

There is also provided a method of coordinating a plurality of collocated radio devices utilizing an interconnect to which all radio devices are connected, comprising the steps of a first radio device that intends to transmit a wireless signal sending a utilization signal to the interconnect for reception by all other radio devices coupled to the interconnect, wherein the utilization signal comprises an indication of the identity of the radio device sending the signal and an indication of an intention to utilize a radio resource.

The method may further comprise the step of all other radio devices coupled to the interconnect receiving the utilization signal and ascertaining the identity of the first radio device.

The utilization signal may be transmitted at baseband or at radio frequency.

Each radio device may be assigned a unique code indicating its identity.

The unique code of each radio device may be orthogonal to the code of all other radio devices coupled to the interconnect.

The intended utilization of the radio resource may be for transmission of a signal.

The intended utilization of the radio resource may be for reception of a signal.

The methods described herein may be performed by firmware or software in machine readable form on a storage medium. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a prior art wireless communications system having two radio devices;

FIG. 2 is a schematic diagram of a wireless communications system having a plurality of radio devices and an interconnect;

FIG. 3 shows a flow-chart of a method of operating a system utilizing an interconnect to coordinate transmission of wireless signals by collocated radio devices; and

FIG. 4 is a schematic diagram of a wireless communications system having a plurality of radio devices capacitively coupled to an interconnect.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

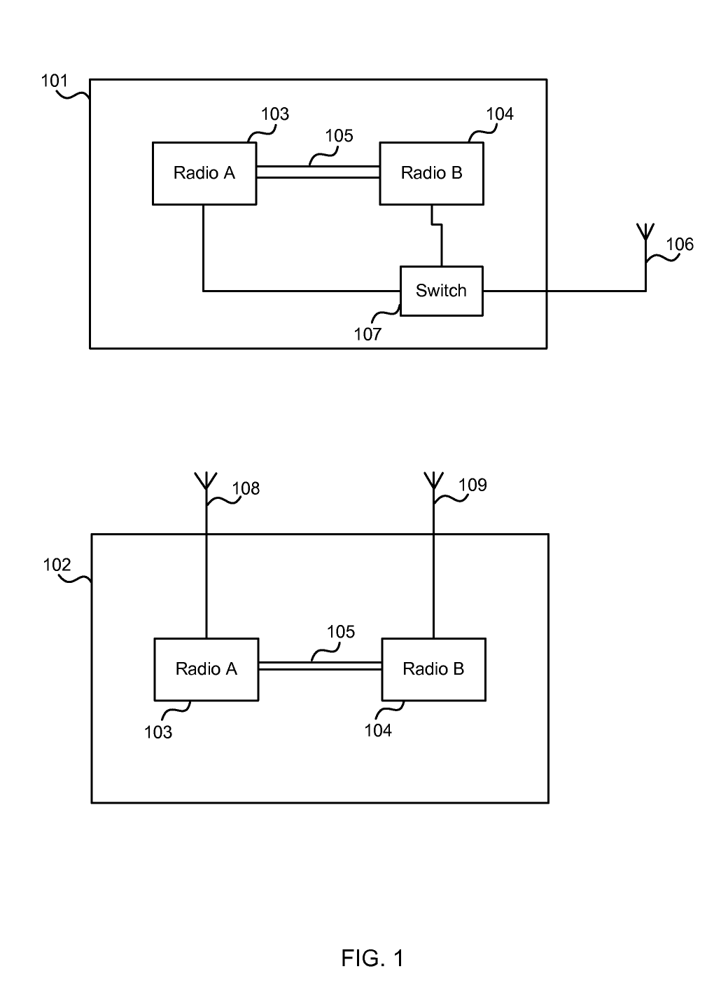

FIG. 1 shows two schematic diagrams of prior-art wireless communications systems 101, 102, which each comprise two radio devices 103, 104, and which are connected by a point to point signaling link 105. In the first device 101, the two radio devices share a single antenna 106 and a switch 107 is used to switch the antenna between the two radio devices. In such a system, the switch 107 may be operated by one of the two radio devices or by a separate entity (e.g. a dedicated Packet Traffic Arbitration (PTA) system). In the second device system, each radio device 103, 104 has a dedicated antenna 108, 109. In both example systems, the two radio devices 103, 104 use TDM to share a resource, where the resource may be bandwidth (e.g. where both radio devices operate in the same frequency band) and/or may be physical hardware (such as antenna 106). Point to point signaling link 105 may be utilized by the radio devices to coordinate sharing of the resource. As the number of collocated radio devices increases, the complexity of the signaling system increases in order to allow each radio device to communicate with all other radio devices.

In an example, the isolation between the two radio devices (e.g. due to the proximity of antennas 108, 109 or the reverse isolation provided by the switch 107) may be less than 20 dB.

In an example, the first radio device 103 may be a Bluetooth radio and the second radio device 104 may be a Wi-Fi radio. Other common examples of combinations of radios are Bluetooth and WiMAX (IEEE 802.16), Wi-Fi and UWB (Ultra Wide Band), and, Wi-Fi and WiMAX. Furthermore more than two radios may be collocated. Also, more than one radio of the same type may be collocated. As described above, collocated radio devices can cause interference and as a result coexistence schemes may be used to mitigate this interference by sharing radio resources.

The device in FIG. 1 comprises two radio devices. In another example, there may be more than two collocated radios and in which case provision needs to be made to allow each of the radios to operate in the presence of the other radios. If the technique shown in FIG. 1 is used to interconnect the radios in such an example, the pin-count of the radios thus increases as the number of collocated radios increase.

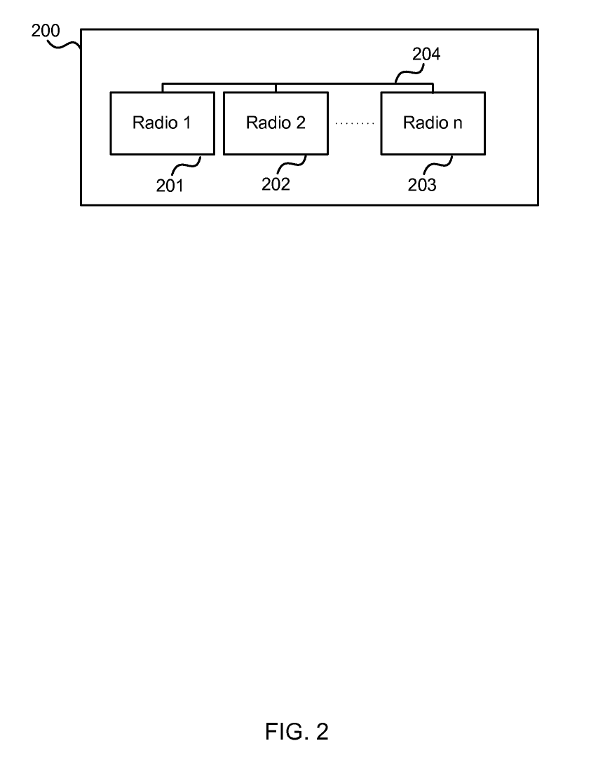

FIG. 2 shows a schematic diagram of a wireless communications system 200 having a plurality of collocated radio devices 201, 202, 203. As represented by Radio n, the system may comprise from 2 to any number of radio devices. The radio devices are connected to an antenna system (not shown), for example as described in relation to FIG. 1. The radio devices are each linked to a coexistence interconnect 204 which comprises a link between the radio devices.

For baseband utilization of the interconnect the radio devices may be resistively coupled to the interconnect according to known techniques. For example, an open drain resistive coupling to an impedance controlled signal line may be suitable. The interconnect forms a multi-drop bus such that each radio device can transmit and receive information all of the other radio devices. The interconnect may be implemented as a single- or multi-wire bus to provide an electrical connection between the devices. Such a system allows each radio device to communicate its requirements for the radio link (or other shared resource) directly to all other collocated radio devices, thereby enabling efficient sharing of that resource. Each of the radio devices communicate at baseband according to an agreed protocol which defines a number of aspects, including procedures for collision detection and resolution. An established standard could be utilized for the protocol, for example Ethernet or a protocol particularly suited to the system may be implemented.

Existing signaling schemes are generally digital schemes and the bandwidth is therefore limited by intersymbol interference. The current system allows the use of modulation techniques, thereby significantly increasing the bandwidth of the interconnect and hence the quantity of information that can be exchanged.

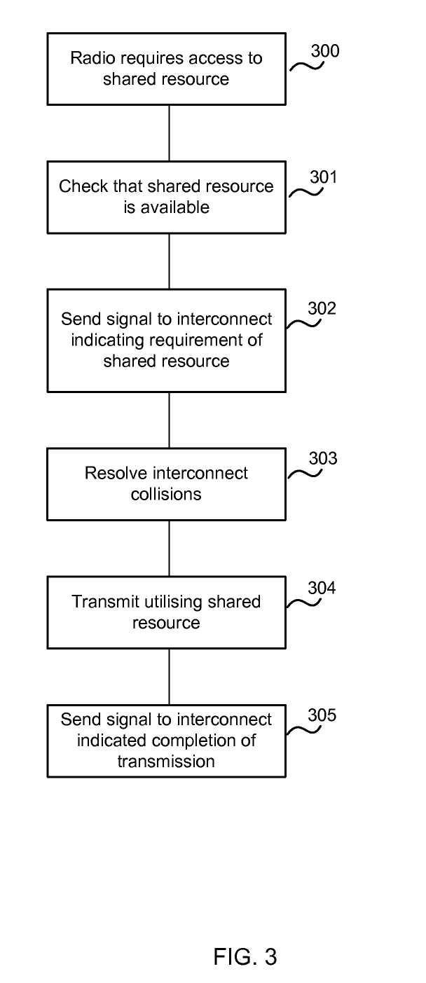

FIG. 3 shows a flow chart of a method utilizing the interconnect system described in relation to FIG. 2. At block 300 radio device 201 wishes to utilize the radio resource, for example to transmit a signal, and thus must inform the other radio devices such that the resource can be shared without interference between the devices. At block 301 radio device 201 checks that it has not received an indication from any other radio devices that the resource is not available, and that accordingly it can utilize the resource.

At block 302 radio device 201 sends a signal to the interconnect according as defined by the protocol. In an embodiment that signal indicates that radio device 201 is now utilizing the resource and will continue to do so until a further signal is sent to the interconnect. Upon receipt of that signal the other radio devices are then aware that the resource is not available and that they cannot utilize the resource until a subsequent signal is received.

At block 303 any collisions on the interconnect are resolved according to the defined protocol, and at block 304 radio device 201 makes the intended use of the resource. At block 305, when the intended use has been completed, radio device 201 sends a signal to the interconnect indicating that it has completed its use of the resource. The other radio devices are therefore notified that the resource is available and that they can utilize it if required (subject to providing notification via the interconnect). An arbitration system within one of the radio devices, or in a separate device, may be utilized to resolve collisions.

According to the above method, each radio device is directly aware of the resource needs of all of the other radio devices sharing the resource, and accordingly scheduling of the resource can be efficiently managed according to defined rules. As will be apparent to the skilled person, the provision of the interconnect allows a range of scheduling processes to be defined between the radio devices such that they can operate efficiently. For example, each radio device may be allocated a priority relative to the other radio devices, such that higher priority radio devices can signal to lower priority radio devices to stop utilizing the resource to allow the higher-priority radio device to transmit. Furthermore, the method described in relation to FIG. 3 may be modified according to the specific requirements of a particular system. For example, the signal indicating that a radio device requires the resource may indicate the duration for which that resource is required. There is then no need to send the ‘end of use of resource’ signal because that information is contained in the initial signal indicating the duration of use. The connection of all the radio devices to a signal bus aids the scalability of the system to increase the number of collocated radio devices.

In a further embodiment, the radio devices may utilize Code Division Multiple Access (CDMA) techniques to communicate. In a CDMA system each radio device is assigned a unique code. Signals sent to the interconnect by each radio device are encoded according to the radio device's unique code such that the source of the particular signal can be identified by the other radio devices, even though there may be other signals also present on the interconnect. This may remove the requirement for collision detection and resolution systems for the interconnect as colliding signals can be extracted using the code.

In an exemplary CDMA system, each radio device is assigned a code which is orthogonal to the codes assigned to each of the other radio devices connected to the interconnect. Each radio device is aware of the code assigned to each of the other radio devices such that received signals can be decoded and thus each radio device can interpret signals sent to the interconnect by each of the other radio devices. When a radio device intends to utilize a shared resource, it sends a signal to the interconnect indicating that intended use, encoded with its code. Upon reception of that signal, the other radio devices correlate the signal with the codes known to be used on the interconnect and can thereby ascertain the source and content of the signal. If multiple radio devices send signals to the interconnect at the same time, each signal can be recovered due to the orthogonal codes utilized by each radio device. Since it is possible for each radio device to simultaneously claim the shared resource, a mechanism for arbitrating between radio devices in that event should be provided. For example, a priority may be assigned to each radio device such that when more than one radio device indicates its intended use of the shared resource at the same time, only the highest priority radio device continues to transmit.

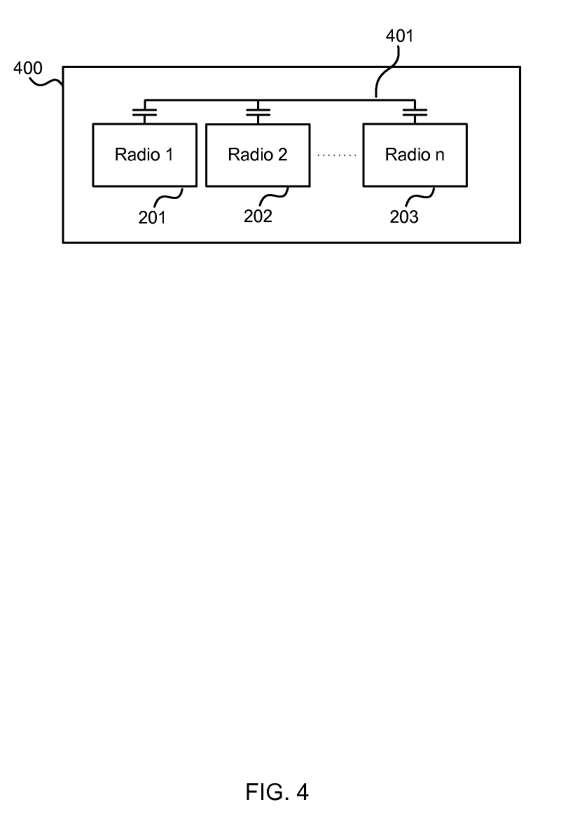

FIG. 4 shows an embodiment 400 in which each radio device is capacitively coupled to the interconnect. The interconnect 401 is utilized to carry Radio Frequency (RF) signals between the radio devices. Such a system provides an efficient method of coupling radio devices to the interconnect and enabling signaling between those radio devices. Any of the techniques described above may be implemented at RF, rather than baseband as previously described. The use of RF may reduce the latency of the link compared to baseband because that latency is not dominated by the RC constant of the interconnect and is thereby reduced. The use of RF may also allow an increase in the bandwidth of transmitted signals, thereby allowing the exchange of more complex signals and information.

The radio devices may turn on and off at arbitrary times in order to conserve power. Capacitive coupling of the radio devices to the interconnect may prevent such switching from affecting the operation of the interconnect. For example, resistive coupling may lead to a turned-off device drawing parasitic power from the interconnect, or the impedance of the interconnect may change depending on the number of devices that are turned on.

An interconnect operating at RF also enables the use of Frequency Division Multiplexing (FDM) for signaling via the interconnect. Each radio device may be assigned a different frequency on which it can transmit to the interconnect. Upon receipt of a signal at a certain frequency, the receiving radio devices are thus each aware of the source of the signal and hence which radio device intends to utilize the shared resource. Such a system operates in a similar manner to the CDMA system described above.

CDMA and FDM are just two examples of RF multiplexing techniques which may be used to communicate over the single-wire link. In other examples, other RF multiplexing techniques may be used.

The above description of signaling between the radio devices is intended as an example only, and as will be apparent to the skilled person, many signaling schemes may be utilized. In the above embodiments, each radio device transmits a signal when it wishes to utilize the shared resource and then proceeds to transmit the signal. More complex systems can be implemented whereby each radio device indicates its planned usage of the shared resource in advance and a scheduling algorithm arbitrates between the radio devices to ensure efficient use of the shared resource. Furthermore, each radio device may plan their activities according to the indicated requirements of the other radio devices. The coordination of activity may be performed by each radio device, or by a master device which gathers information from each radio device and provides instructions defining how each radio device should act.

Interference between the radio devices may occur when parts of the radio front-end are shared, or due to local oscillator leakage. The techniques described above in relation to the transmission of signals are therefore equally applicable to the reception of signals, and the radio devices may utilize the techniques to coordinate reception and/or transmission of signals.

In the above description, it has been assumed that each radio device is concerned about the transmission of all other radio devices and that only one radio device can transmit at a given time. However, in certain embodiments, a particular radio device may only have to coordinate with a subset of the other radio devices in the system. Since each radio device can identify the source of signals indicating intended usage, signals from radio devices with which there is no collision can be ignored. Furthermore, intelligence can be incorporated into the system to allow more complex sharing of resources. For example, it may be possible for two radio devices to transmit simultaneously, provided the transmit power is lowered. By communication via the interconnect, such sharing can be implemented. The ability of each radio device to directly receive information from all other radio devices may allow more complex sharing schemes to be implemented because information from all radio devices can be shared more quickly than may be possible using multiple point-to-point links.

The term collocated is used herein to indicate that each radio device is located within a single device, but each radio device may be physically separate within the package of that device. For example, the device may comprise separate circuit boards for Bluetooth and Wi-Fi radio systems, which would be encompassed by the term collocated. Equally, the radio devices may be located on a single circuit board or integrated circuit.

Examples of resistive and capacitive coupling of the radio systems to the interconnect have been provided, but as will be appreciated, other coupling systems may also be utilized. For example, inductive or optical coupling may be implemented if appropriate. Furthermore, the interconnect may be an optical interconnect rather than the electrical interconnect described hereinbefore. Equivalent transmission techniques in the optical domain would then be utilized for communication between the radio devices.

The interconnect has been described herein as a single- or multi-wire electrical connection between the radio devices, but other methods of implementation may be utilized. For example, guided optics or an ultra-low-range radio network may be utilized.

Any range or device value given herein may be extended or altered without losing the effect sought, as will be apparent to the skilled person.

It will be understood that any benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise and exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A wireless communications system, comprising
a plurality of radio devices,
an interconnect to which each of the radio devices is coupled, wherein
each radio device is configured to send a utilization signal to the interconnect for reception by all other radio devices coupled to the interconnect, wherein the utilization signal comprises an indication of the identity of the radio device sending the signal and an indication of an intention to utilize a radio resource.

2. A wireless communications system according to claim 1, wherein the radio devices are resistively coupled to the interconnect.

3. A wireless communications system according to claim 1, wherein the utilization signal is a baseband signal.

4. A wireless communications system according to claim 1, wherein the radio devices are capacitively or inductively coupled to the interconnect.

5. A wireless communications system according to claim 1, wherein the utilization signal is a radio frequency signal.

6. A wireless communications system according to claim 1 wherein each radio device is assigned a unique code indicating its identity.

7. A wireless communications system according to claim 6 wherein the code of each radio device is orthogonal to the code of each other radio device.

8. A wireless communications system according to claim 6 wherein the utilization signal comprises the code of the radio device sending that signal.

9. A wireless communications system according to claim 6 wherein the utilization signal is a radio frequency signal and the identity of the radio device is indicated by encoding the radio frequency signal with the code of the radio device sending the utilization signal.

10. A wireless communications system according to claim 5 wherein the identity of the radio device is indicated by the frequency of the utilization signal.

11. A wireless communications system according to claim 1 wherein 3 or more radio device are coupled to the interconnect.

12. A wireless communications system according to claim 1 wherein the plurality of radio devices are mounted on a single circuit board.

13. A wireless communications system according to claim 1 wherein at least two of the radio devices share an antenna.

14. A wireless communications system according to claim 1 wherein the interconnect is a single-wire interconnect.

15. A wireless communications system according to claim 1 wherein the radio devices are optically coupled to the interconnect.

16. A wireless communications system according to claim 1, wherein the intended utilization of the radio resource is for transmission of a signal.

17. A wireless communications system according to claim 1, wherein the intended utilization of the radio resource is for reception of a signal.

18. A method of coordinating a plurality of collocated radio devices utilizing an interconnect to which all radio devices are connected, comprising
a first radio device that intends to transmit a wireless signal sending a utilization signal to the interconnect for reception by all other radio devices coupled to the interconnect, wherein the utilization signal comprises an indication of the identity of the radio device sending the signal and an indication of an intention to utilize a radio resource.

19. A method according to claim 18, further comprising the step of
all other radio devices coupled to the interconnect receiving the utilization signal and ascertaining the identity of the first radio.

20. A method according to claim 18, wherein the utilization signal is transmitted at baseband.

21. A method according to claim 18, wherein the utilization signal is transmitted at radio frequency.

22. A method according to claim 18 wherein each radio device is assigned a unique code indicating its identity.

23. A method according to claim 22 wherein the unique code of each radio device is orthogonal to the code of all other radio devices coupled to the interconnect.

24. A method according to claim 18 wherein the intended utilization of the radio resource is for transmission of a signal.

25. A method according to claim 18 wherein the intended utilization of the radio resource is for reception of a signal.
